(19) United States
(12) Patent Application Publication
(10) Pub. No.: US 2026/0264355 A1
(43) Pub. Date: Sep. 10, 2026

(54) METHOD OF MANUFACTURING SHEAR WEBS FOR ROTOR BLADES

(71) Applicant: LM Wind Power A/S, Kolding (DK)

(72) Inventors: Lars Nielsen, Lunderskov (DK); Klavs Jespersen, Lunderskov (DK)

(21) Appl. No.: 18/869,404

(22) PCT Filed: May 30, 2022
(86) PCT No.: PCT/EP2022/064567

§ 371 Date: Nov. 26, 2024

(51) Int. Cl. B29D 99/00; F03D 1/06

(52) U.S. Cl. CPC B29D 99/0028; F03D 1/0684; F05B 2230/23

(57) ABSTRACT

A method of manufacturing a jointed structural component of a rotor blade includes forming at least one first portion of the jointed structural component via at least one custom mold. The first portion(s) has one or more custom characteristics with respect to the rotor blade. The method also includes providing at least one second portion of the jointed structural component. The second portion(s) of the jointed structural component is a pre-fabricated component. The method further includes arranging the first portion(s) and the second portion(s) of the jointed structural component together at an interface. Moreover, the method includes joining the first portion(s) and the second portion(s) together at the interface to create the jointed structural component.

### FIELD

The present disclosure relates generally to rotor blades, and more particularly to methods of manufacturing shear webs for rotor blades, such as wind turbine rotor blades.

### BACKGROUND

Wind power is considered one of the cleanest, most environmentally friendly energy sources presently available, and wind turbines have gained increased attention in this regard. A modern wind turbine typically includes a tower, a generator, a gearbox, a nacelle, and a rotor having a rotatable hub with one or more rotor blades. The rotor blades capture kinetic energy of wind using known airfoil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The rotor blades generally include a suction side shell and a pressure side shell typically formed using molding processes that are bonded together at bond lines along the leading and trailing edges of the blade. Further, the pressure and suction shells are relatively lightweight and have structural properties (e.g., stiffness, buckling resistance and strength) which are not configured to withstand the bending moments and other loads exerted on the rotor blade during operation. Thus, to increase the stiffness, buckling resistance and strength of the rotor blade, the body shell is typically reinforced using one or more structural components (e.g., opposing spar caps with a shear web configured therebetween) that engage the inner pressure and suction side surfaces of the shell halves. The rotor blade shells are typically constructed of a laminate having sandwich-panel configuration that includes low stiffness glass fibers.

As wind turbines continue to increase in size, the rotor blades also increase in size. Thus, manufacturing of larger rotor blades (e.g., 90-meter long rotor blades) takes up a considerable footprint. As an example, a typical shear web is manufactured using a custom mold that is sized to accommodate the entire length of the shear web. However, the majority of the shear web is constructed of simple, flat sandwich panels. As such, a larger majority of the materials and mold surface required for manufacturing conventional shear webs is used to mold the simple flat sandwich panels.

Accordingly, the present disclosure is directed to methods of manufacturing shear webs for rotor blades, such as wind turbine rotor blades, that addresses the aforementioned issues. In particular, the present disclosure is directed to methods of manufacturing shear webs for rotor blades that substantially reduces the footprint of the overall manufacturing process.

### BRIEF DESCRIPTION

Aspects and advantages of the invention will be set forth in part in the following description, or may be obvious from the description, or may be learned through practice of the invention.

In one aspect, the present disclosure is directed to a method of manufacturing a jointed structural component of a rotor blade. The method includes forming at least one first portion of the jointed structural component via at least one custom mold. The first portion(s) has one or more custom characteristics with respect to the rotor blade. The method also includes providing at least one second portion of the jointed structural component. The second portion(s) of the jointed structural component is a pre-fabricated component. The method further includes arranging the first portion(s) and the second portion(s) of the jointed structural component together at an interface. Moreover, the method includes joining the first portion(s) and the second portion(s) together at the interface to create the jointed structural component. It should be further understood that the method may also include any of the additional steps and/or features described herein.

In one aspect, the present disclosure is directed to a method of manufacturing a shear web of a rotor blade. The method includes forming a first custom foot portion and a second custom foot portion of the shear web together as an integral, single component in at least one custom mold. Further, the method includes cutting the integral, single component after the forming to separate the first custom foot portion from the second custom foot portion. Moreover, the method includes providing at least one second portion of the shear web. The second portion(s) of the shear web is a pre-fabricated component. In addition, the method includes arranging the first and second custom foot portions and the second portion(s) of the shear web together at an interface. Further, the method includes joining the first and second custom foot portions and the second portion(s) together at the interface to create the shear web. It should be further understood that the method may also include any of the additional steps and/or features described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of an embodiment of a wind turbine according to the present disclosure;

FIG. 2 illustrates a perspective view of an embodiment of a rotor blade of a wind turbine according to the present disclosure;

FIG. 3 illustrates a cross-sectional view of an embodiment of a rotor blade of a wind turbine according to the present disclosure;

FIG. 4 illustrates a perspective view of an embodiment of a shear web of a rotor blade of a wind turbine according to the present disclosure;

FIG. 5 illustrates a flow diagram of an embodiment of a method of manufacturing a jointed structural component of a rotor blade according to the present disclosure;

FIG. 6A illustrates a schematic diagram of an embodiment of a manufacturing process for a jointed structural component of a rotor blade according to the present disclosure, particularly illustrating a molding process for forming first and second custom foot portions of a larger shear web;

FIG. 6B illustrates a schematic diagram of an embodiment of a manufacturing process for a jointed structural component of a rotor blade according to the present disclosure, particularly illustrating a molding process for forming first and second custom foot portions of a smaller shear web;

FIG. 7A illustrates a schematic diagram of an embodiment of a manufacturing process for a jointed structural component of a rotor blade according to the present disclosure, particularly illustrating first and second custom foot portions and a standard portion of a larger shear web arranged in an assembly jig; and

FIG. 7B illustrates a schematic diagram of an embodiment of a manufacturing process for a jointed structural component of a rotor blade according to the present disclosure, particularly illustrating first and second custom foot portions and a standard portion of a smaller shear web arranged in an assembly jig.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

For many conventional shear web manufacturing processes, a majority of the materials and mold surface needed to manufacture the component is used to mold simple, flat sandwich panels. Thus, the present disclosure is directed to improved manufacturing methods that reduced the manufacturing facility footprint by up to about 90%, while maintaining the structural integrity of the shear web.

In particular, in an embodiment, methods of the present disclosure reduce the mold shape to include only custom portions of the shear web, such as the upwind and downwind web foot structures, plus some additional core materials. After curing, the molded part can be cut along the centerline using a fixed reference point on either the upwind or downwind web flange. The core can further be optionally tapered to a pre-selected common thickness for the majority of the shear web if desired. As such, the web foot of the shear web can be optimized for custom blade sizes with respect to foot angle, foot radius, foot/flange width, pry capacity, core thickness, and/or fiber reinforcement layup, which is particularly useful as the web foot angle and peel and pry strength are critical for an efficient blade shear web. Moreover, in an embodiment, in an assembly jig, the custom upwind and downwind web foot structures can be joined with pre-manufactured sandwich sheets cut to sizes that can be easily handled during the assembly, e.g., such as from about one meter to about six (6) meters (m), or up to 12 m, or up to 15 m. The sandwich panels can be joined with the web foot structures and the neighbor panel by either single or double lapped joints, abutted or V-notched adhesive joints, lamination, and/or mechanical joints.

Accordingly, the present disclosure provides many advantages not known in the prior art. For example, by combining fully customized web structures with standard components, the manufacturing facility footprint can be reduced by up to about 90%.

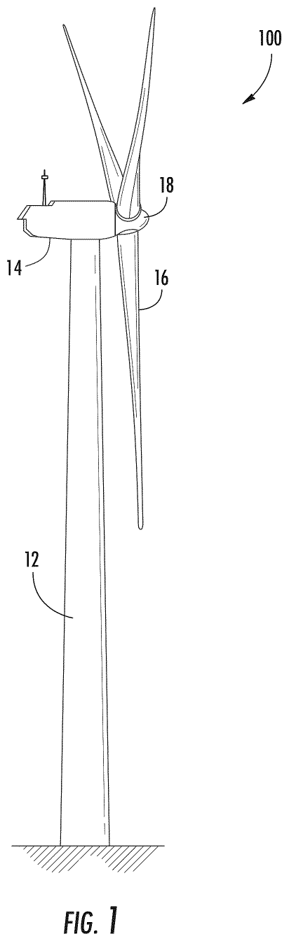

Referring now to the drawings, FIG. 1 illustrates a perspective view of a horizontal axis wind turbine 10 according to the present disclosure. It should be appreciated that the wind turbine 10 may also be a vertical-axis wind turbine. As shown in the illustrated embodiment, the wind turbine 10 includes a tower 12, a nacelle 14 mounted on the tower 12, and a rotor hub 18 that is coupled to the nacelle 14. The tower 12 may be fabricated from tubular steel or other suitable material. The rotor hub 18 includes one or more rotor blades 16 coupled to and extending radially outward from the hub 18. The rotor blades 16 rotate the rotor hub 18 to enable kinetic energy to be transferred from the wind into usable mechanical energy, and subsequently, electrical energy. Specifically, the hub 18 may be rotatably coupled to an electric generator (not illustrated) positioned within the nacelle 14 for production of electrical energy.

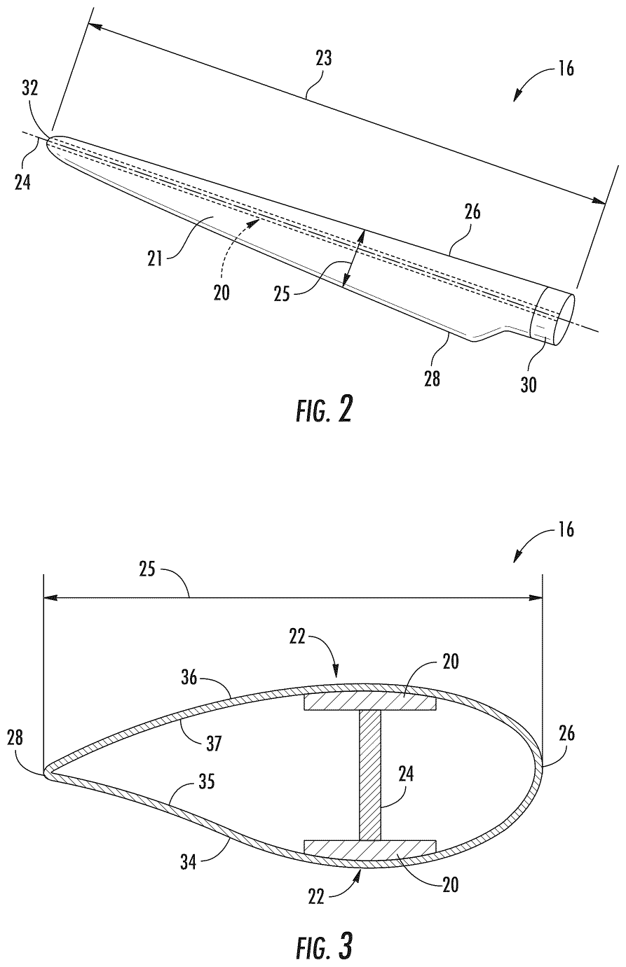

Referring to FIGS. 2 and 3, one of the rotor blades 16 of FIG. 1 is illustrated in accordance with aspects of the present disclosure. In particular, FIG. 2 illustrates a perspective view of the rotor blade 16, whereas FIG. 3 illustrates a cross-sectional view of the rotor blade 16. As shown, the rotor blade 16 generally includes a blade root 30 configured to be mounted or otherwise secured to the hub 18 (FIG. 1) of the wind turbine 10 and a blade tip 32 disposed opposite the blade root 30. A body shell 21 of the rotor blade 16 generally extends between the blade root 30 and the blade tip 32 along a longitudinal axis 27. The body shell 21 may generally serve as the outer casing/covering of the rotor blade 16 and may define a substantially aerodynamic profile, such as by defining a symmetrical or cambered airfoil-shaped cross-section. The body shell 21 may also define a pressure side 34 and a suction side 36 extending between leading and trailing edges 26, 28 of the rotor blade 16. Further, the rotor blade 16 may also have a span 23 defining the total length between the blade root 30 and the blade tip 32 and a chord 25 defining the total length between the leading edge 26 and the trialing edge 28. As is generally understood, the chord 25 may generally vary in length with respect to the span 23 as the rotor blade 16 extends from the blade root 30 to the blade tip 32.

In several embodiments, the body shell 21 of the rotor blade 16 may be formed as a single, unitary component. Alternatively, the body shell 21 may be formed from a plurality of shell components 22. For example, the body shell 21 may be manufactured from a first shell half 22 generally defining the pressure side 34 of the rotor blade 16 and a second shell half 22 generally defining the suction side 36 of the rotor blade 16, with such shell halves being secured to one another at the leading and trailing edges 26, 28 of the blade 16. Additionally, the body shell 21 may generally be formed from any suitable combination of materials. For instance, in one embodiment, the body shell 21 may be formed entirely from a laminate composite material, such as a carbon fiber reinforced laminate composite or a glass fiber reinforced laminate composite. Alternatively, one or more portions of the body shell 21 may be configured as a layered construction and may include a core material, formed from a lightweight material such as wood (e.g., balsa), foam (e.g., extruded polystyrene foam) or a combination of such materials, disposed between layers of laminate composite material.

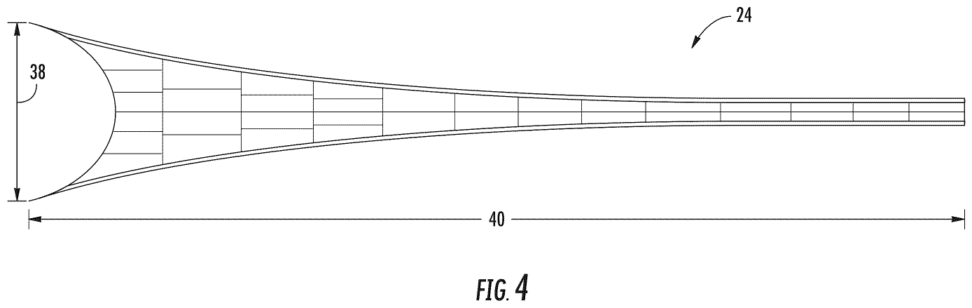

Referring now to FIGS. 3 and 4, the rotor blade 16 may also include one or more longitudinally extending structural components configured to provide increased stiffness, buckling resistance and/or strength to the rotor blade 16. For example, as shown in FIG. 3, the rotor blade 16 may include a pair of longitudinally extending spar caps 20 configured to be engaged against the opposing inner surfaces 35, 37 of the pressure and suction sides 34, 36 of the rotor blade 16, respectively. Additionally, one or more shear webs 24 may be disposed between the spar caps 20 to form a beam-like configuration. Multiple I-beam structures may be used with respective spar caps 20 in accordance with aspects of the invention. The spar caps 20 may generally be designed to control the bending stresses and/or other loads acting on the rotor blade 16 in a generally spanwise direction (a direction parallel to the span 23 of the rotor blade 16) during operation of a wind turbine 10. Similarly, the spar caps 20 may also be designed to withstand the spanwise compression occurring during operation of the wind turbine 10.

Referring particularly to FIG. 4, a perspective view of an embodiment of the shear web 24 of the rotor blade 16 according to the present disclosure is illustrated. More specifically, as shown, the shear web 24 generally defines a total web height 38 and a total web length 40 extending from the blade root 30 to the blade tip 32. Further, as shown, the total web height 38 generally varies down the span 23 of the rotor blade 16, with the tallest portion being near the blade root 30 and the shortest portion being near the blade root 32. In addition, as shown, the shear web 24 according to the present disclosure has a generally segmented or jointed configuration, which will be described herein in greater detail below.

Referring now to FIG. 5, a flow diagram of an embodiment of method 100 of manufacturing a jointed structural component of a rotor blade, such as the shear web 24, according to the present disclosure is illustrated. It should be appreciated that the method 100 may be implemented to manufacture any suitable shear web having any suitable configuration. In several embodiments, for example, the shear web may be part of a rotor blade that is used by a wind turbine. However, it should be further understood that the rotor blades described herein may be used in any other suitable application, such as aircrafts. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown at (102), the method 100 includes forming at least one first portion of the jointed structural component via at least one custom mold. The first portion(s) has one or more custom characteristics with respect to the rotor blade 16.

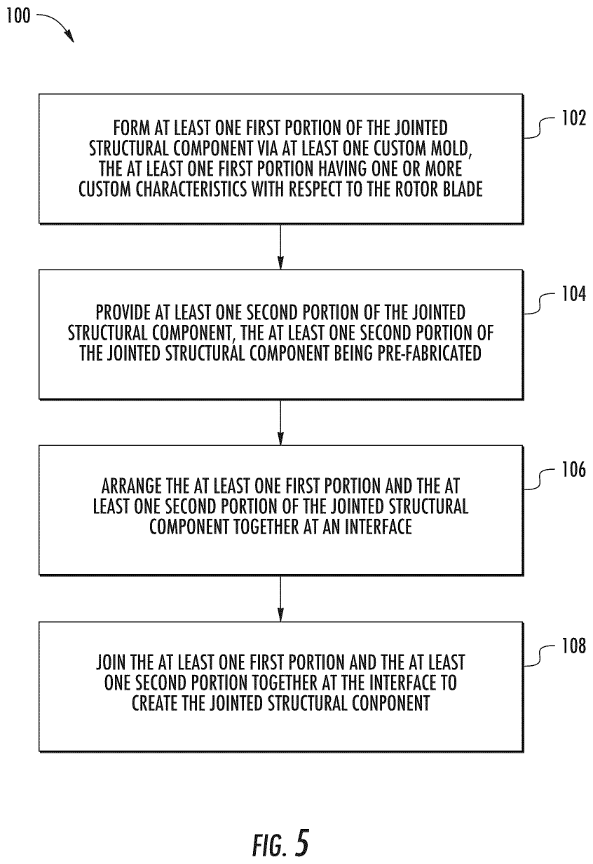

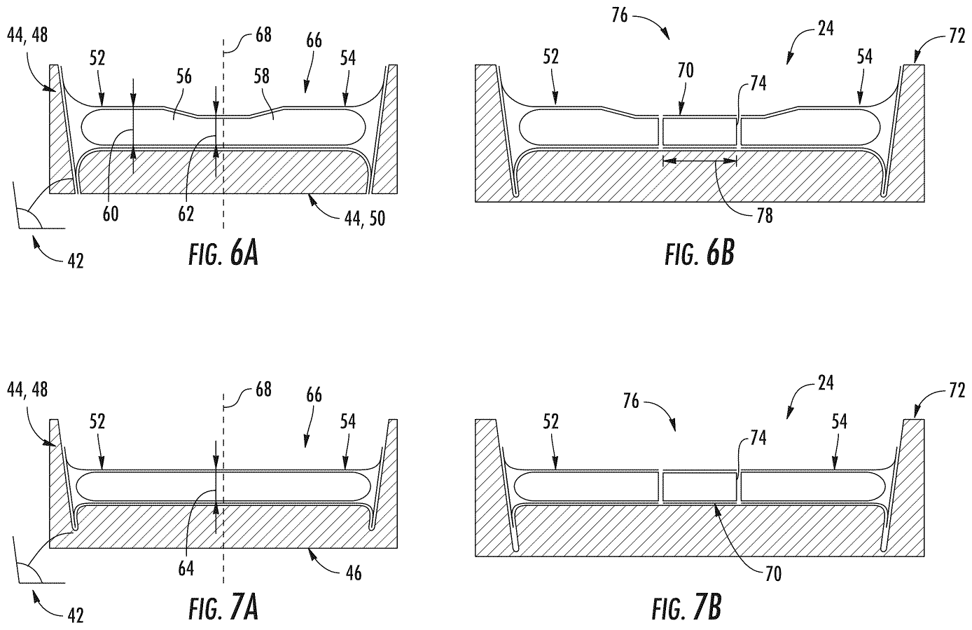

For example, in an embodiment, the custom characteristic(s) may include a foot angle 42 (FIGS. 6A and 7A), a foot radius, a core thickness, and reinforcement layup of the shear web 24.

Forming of the first portion of the jointed structural component can be better understood with reference to FIGS. 6A-7B. As shown in the illustrated embodiment, the jointed structural component is the shear web 24 described herein.

Further, FIGS. 6A and 6B illustrate a manufacturing process for larger portions of the shear web 24 of the rotor blade 16, whereas FIGS. 7A and 7B illustrate a manufacturing process for smaller portions of the shear web 24 of the rotor blade 16. As used herein, a “small” or “large” web size is generally understood as the local web size at a particular blade cross section. For example, a 100-meter long rotor blade can have multiple web sizes, such as three different web sizes, starting with large web sizes in the root area and smaller web sizes in the tip area. Thus, as shown in each of FIGS. 6A and 7B, the first portion(s) of the shear web 24 may be formed via one or more custom mold assemblies 44, 46, depending on the size of the shear web 24. In particular, as shown in FIG. 6A, the custom mold assembly 44 for the shear web 24 may include one or more outer molds 48 and one or more inner mold inlays 50. Thus, the custom mold assembly 44 for forming larger shear webs can include multiple parts for easier management thereof. Alternatively, as shown in FIG. 7A, the custom mold assembly 46 for smaller shear webs may be formed of a single mold component.

Still referring to FIGS. 6A and 7A, forming of the first portion(s) of the jointed structural component may include forming a first custom foot portion 52 and a second custom foot portion 54 of the shear web 24 in the custom mold assemblies 44, 46. In particular embodiments, as shown, the first and second custom foot portions 52, 54 may be formed integrally together in the mold assemblies 44, 46 as a single component 66.

In certain embodiments, as shown in FIG. 6A, one or both of the first and second custom foot portions 52, 54 of the shear web 24 may be formed with a tapered region 56, 58. Thus, in such embodiments, as shown, the tapered regions 56, 58 provide a transition from a first thickness 60 to second thickness 62, which will be further described herein below. In contrast, as shown in FIG. 7A, one or both of the first and second custom foot portions 52, 54 of the shear web 24 may be formed with a constant thickness 64, which is common in smaller shear webs.

Referring now to FIGS. 6B and 7B, the method 100 may also include cutting or otherwise machining the single component (e.g., formed in FIGS. 6A and 7A) after forming thereof so as to separate the first custom foot portion 52 from the second custom foot portion 54. In such embodiments, as an example, the single component 66 may be cut along a centerline 68 of the first and second custom foot portions 52, 54 using a fixed reference point (e.g., along the centerline 68) on either an upwind flange or a downwind web flange of the shear web 24 of the wind turbine 10 to separate the first custom foot portion 52 from the second custom foot portion 54.

Referring back to FIG. 5, as shown at (104), the method 100 includes providing at least one second portion 70 of the jointed structural component. In such embodiments, as shown particularly in FIGS. 6B and 7B, the second portion(s) 70 of the jointed structural component is a pre-fabricated component that has a sandwich panel configuration. For example, as shown in FIGS. 6B and 7B, the second portion(s) 70 may be generally standard, simple, flat sandwich panels that are shipping to the manufacturing facility. Thus, by using such prefabricated components, the manufacturing methods described herein can be accomplished with a reduced plant footprint, such as up to 90%, while also maintaining the structural advantage of the I-beam of the shear web 24. Moreover, as shown in FIGS. 6B and 7B, a maximum dimension 78 of the second portion(s) 70 of the jointed structural component may be equal to or less than about six (6) meters (m), such as about 1 m to about 5 m, to make for easy handling by an operator.

Furthermore, as shown, a thickness 64 of the second portion(s) 70 is generally equal to the second thickness 62 of the first and second custom foot portions 52, 54 having the tapered regions 56, 58 for larger rotor blades (FIG. 6A) or the constant thickness 64 of the first and second custom foot portions 52, 54 for smaller rotor blades (FIG. 7A). Thus, adjacent parts can be easily joined together as described in more detail herein below.

As shown at (106), the method 100 includes includes arranging the first portion(s) (e.g., the first and second custom foot portions 52, 54) and the second portion(s) 70 of the jointed structural component in an assembly jig 72 at an interface. For example, as shown in FIGS. 6B and 7B, the first custom foot portion 52 and the second custom foot portion 54 of the shear web 24 may be arranged at opposing ends of the assembly jig 72 such that the first and second custom foot portions 52, 54 are separated from each other via a gap 74. Thus, as shown, the second portion(s) 70 can be arranged between the first custom foot portion 52 and the second custom foot portion 54 within the gap 74.

Referring back to FIG. 5, as shown at (108), the method 100 includes joining the first portion(s) (e.g., the first and second custom foot portions 52, 54) and the second portion(s) 70 together at the interface 76 to create the jointed structural component (e.g., the shear web 24). For example, in an embodiment, the first and second custom foot portions 52, 54 may be joined or otherwise secured to the second portion 70 together at the interface 76 using at least one of a single lapped joint, a double lapped joint, an abutted adhesive joint, a V-notched adhesive joint, lamination, or one or more mechanical joints.

The skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

Further aspects are provided by the subject matter of the following clauses:

Clause 1. A method of manufacturing a jointed structural component of a rotor blade, the method comprising:
forming at least one first portion of the jointed structural component via at least one custom mold, the at least one first portion having one or more custom characteristics with respect to the rotor blade;
providing at least one second portion of the jointed structural component, the at least one second portion of the jointed structural component being a pre-fabricated component;
arranging the at least one first portion and the at least one second portion of the jointed structural component together at an interface; and
joining the at least one first portion and the at least one second portion together at the interface to create the jointed structural component.

Clause 2. The method of clause 1, wherein the pre-fabricated component comprises a sandwich panel configuration.

Clause 3. The method of clauses 1-2, wherein the jointed structural component is a shear web of the rotor blade.

Clause 4. The method of clause 3, wherein the one or more custom characteristics of the at least one first portion comprise at least one of a foot angle, a foot radius, a core thickness, and reinforcement layup of the shear web.

Clause 5. The method of clause 3, wherein the rotor blade is part of a wind turbine.

Clause 6. The method of clause 5, wherein the at least one first portion comprises a first custom foot portion and a second custom foot portion, wherein forming the at least one first portion of the jointed structural component via the at least one custom mold further comprises:
forming the first and second custom foot portions of the shear web in the at least one custom mold, the first and second custom foot portions being formed integrally together as a single component.

Clause 7. The method of clause 6, wherein forming the first and second custom foot portions of the shear web in the at least one custom mold further comprises:
forming each of the first and second custom foot portions of the shear web with a tapered region, the tapered regions comprising a transition from a first thickness to second thickness that is equal to a thickness of the at least one second portion of the jointed structural component.

Clause 8. The method of clause 6, further comprising cutting the single component after the forming to separate the first custom foot portion from the second custom foot portion.

Clause 9. The method of clause 8, wherein cutting the single component after the forming to separate the first custom foot portion from the second custom foot portion further comprises:
cutting the single component after the forming along a centerline of the at least one first portion using a fixed reference point on either an upwind flange or a downwind web flange of the shear web of the wind turbine to separate the first custom foot portion from the second custom foot portion.

Clause 10. The method of clause 8, wherein arranging the at least one first portion and the at least one second portion of the jointed structural component together at the interface further comprises:
arranging the first custom foot portion and the second custom foot portion of the shear web at opposing ends of an assembly jig such that the first and second custom foot portions are separated from each other via a gap; and
arranging the at least one second portion between the first custom foot portion and the second custom foot portion within the gap.

Clause 11. The method of any of the preceding clauses, wherein joining the at least one first portion and the at least one second portion together at the interface to create the jointed structural component further comprises joining the at least one first portion and the at least one second portion together at the interface using at least one of a single lapped joint, a double lapped joint, an abutted adhesive joint, a V-notched adhesive joint, lamination, or one or more mechanical joints.

Clause 12. The method of any of the preceding clauses, wherein a maximum dimension of the at least one second portion of the jointed structural component is equal to or less than about 15 meters.

Clause 13. A method of manufacturing a shear web of a rotor blade, the method comprising:
forming a first custom foot portion and a second custom foot portion of the shear web together as an integral, single component in at least one custom mold;
cutting the integral, single component after the forming to separate the first custom foot portion from the second custom foot portion;
providing at least one second portion of the shear web, the at least one second portion of the shear web being pre-fabricated;
arranging the first and second custom foot portions and the at least one second portion of the shear web together at an interface; and
joining the first and second custom foot portions and the at least one second portion together at the interface to create the shear web.

Clause 14. The method of clause 13, wherein the one or more custom characteristics of the at least one first portion comprise at least one of a foot angle, a foot radius, a core thickness, and reinforcement layup of the shear web.

Clause 15. The method of clauses 13-14, wherein the at least one second portion of the jointed structural component has a sandwich panel configuration.

Clause 16. The method of clauses 13-15, wherein forming the first custom foot portion and the second custom foot portion of the shear web together as the single component in the at least one custom mold further comprises:
forming each of the first and second custom foot portions of the shear web with a tapered region, the tapered regions comprising a transition from a first thickness to second thickness that is equal to a thickness of the at least one second portion of the jointed structural component.

Clause 17. The method of clause 17, wherein cutting the integral, single component after the forming to separate the first custom foot portion from the second custom foot portion further comprises cutting the integral, single component after the forming along a centerline thereof using a fixed reference point on either an upwind flange or a downwind web flange of the shear web of the wind turbine to separate the first custom foot portion from the second custom foot portion.

Clause 18. The method of clauses 13-17, wherein arranging the first and second custom foot portions and the at least one second portion of the shear web in the assembly jig at the interface further comprises:
arranging the first custom foot portion and the second custom foot portion of the shear web at opposing ends of the assembly jig such that the first and second custom foot portions are separated from each other via a gap; and
arranging the at least one second portion between the first custom foot portion and the second custom foot portion within the gap.

Clause 19. The method of clauses 13-18, wherein joining the first and second custom foot portions and the at least one second portion together at the interface to create the shear web further comprises:
joining the first and second custom foot portions and the at least one second portion together at the interface using at least one of a single lapped joint, a double lapped joint, an abutted adhesive joint, a V-notched adhesive joint, lamination, or one or more mechanical joints.

Clause 20. The method of clauses 13-19, wherein a maximum dimension of the at least one second portion of the jointed structural component is equal to or less than about 15 meters.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of manufacturing a jointed structural component of a rotor blade, the method comprising:
forming at least one first portion of the jointed structural component via at least one custom mold, the at least one first portion having one or more custom characteristics with respect to the rotor blade;
providing at least one second portion of the jointed structural component, the at least one second portion of the jointed structural component being a pre-fabricated component;
arranging the at least one first portion and the at least one second portion of the jointed structural component together at an interface; and
joining the at least one first portion and the at least one second portion together at the interface to create the jointed structural component.

2. The method of claim 1, wherein the pre-fabricated component comprises a sandwich panel configuration.

3. The method of claim 1, wherein the jointed structural component is a shear web of the rotor blade.

4. The method of claim 3, wherein the one or more custom characteristics of the at least one first portion comprise at least one of a foot angle, a foot radius, a core thickness, and reinforcement layup of the shear web.

5. The method of claim 1, wherein the rotor blade is part of a wind turbine.

6. The method of claim 5, wherein the at least one first portion comprises a first custom foot portion and a second custom foot portion, wherein forming the at least one first portion of the jointed structural component via the at least one custom mold further comprises:
forming the first and second custom foot portions of the shear web in the at least one custom mold, the first and second custom foot portions being formed integrally together as a single component.

7. The method of claim 6, wherein forming the first and second custom foot portions of the shear web in the at least one custom mold further comprises:
forming each of the first and second custom foot portions of the shear web with a tapered region, the tapered regions comprising a transition from a first thickness to second thickness that is equal to a thickness of the at least one second portion of the jointed structural component.

8. The method of claim 1, further comprising cutting the single component after the forming to separate the first custom foot portion from the second custom foot portion.

9. The method of claim 8, wherein cutting the single component after the forming to separate the first custom foot portion from the second custom foot portion further comprises:
cutting the single component after the forming along a centerline of the at least one first portion using a fixed reference point on either an upwind flange or a downwind web flange of the shear web of the wind turbine to separate the first custom foot portion from the second custom foot portion.

10. The method of claim 1, wherein arranging the at least one first portion and the at least one second portion of the jointed structural component together at the interface further comprises:
arranging the first custom foot portion and the second custom foot portion of the shear web at opposing ends of an assembly jig such that the first and second custom foot portions are separated from each other via a gap; and
arranging the at least one second portion between the first custom foot portion and the second custom foot portion within the gap.

11. The method of claim 1, wherein joining the at least one first portion and the at least one second portion together at the interface to create the jointed structural component further comprises joining the at least one first portion and the at least one second portion together at the interface using at least one of a single lapped joint, a double lapped joint, an abutted adhesive joint, a V-notched adhesive joint, lamination, or one or more mechanical joints.

12. The method of claim 1, wherein a maximum dimension of the at least one second portion of the jointed structural component is equal to or less than about 15 meters.

13. A method of manufacturing a shear web of a rotor blade, the method comprising:
forming a first custom foot portion and a second custom foot portion of the shear web together as an integral, single component in at least one custom mold, the first and second custom foot portions having one or more custom characteristics with respect to the shear web;
cutting the integral, single component after the forming to separate the first custom foot portion from the second custom foot portion;
providing at least one second portion of the shear web, the at least one second portion of the shear web being pre-fabricated;
arranging the first and second custom foot portions and the at least one second portion of the shear web together at an interface; and
joining the first and second custom foot portions and the at least one second portion together at the interface to create the shear web.

14. The method of claim 13, wherein the one or more custom characteristics comprise at least one of a foot angle, a foot radius, a core thickness, and reinforcement layup of the shear web.

15. The method of claim 13, wherein the at least one second portion of the shear web has a sandwich panel configuration.

16. The method of claim 13, wherein forming the first custom foot portion and the second custom foot portion of the shear web together as the single component in the at least one custom mold further comprises:
forming each of the first and second custom foot portions of the shear web with a tapered region, the tapered regions comprising a transition from a first thickness to second thickness that is equal to a thickness of the at least one second portion of the shear web.

17. The method of claim 13, wherein cutting the integral, single component after the forming to separate the first custom foot portion from the second custom foot portion further comprises cutting the integral, single component after the forming along a centerline thereof using a fixed reference point on either an upwind flange or a downwind web flange of the shear web of a wind turbine to separate the first custom foot portion from the second custom foot portion.

18. The method of claim 13, wherein arranging the first and second custom foot portions and the at least one second portion of the shear web together at the interface further comprises:
arranging the first custom foot portion and the second custom foot portion of the shear web at opposing ends of an assembly jig such that the first and second custom foot portions are separated from each other via a gap; and
arranging the at least one second portion between the first custom foot portion and the second custom foot portion within the gap.

19. The method of claim 13, wherein joining the first and second custom foot portions and the at least one second portion together at the interface to create the shear web further comprises:
joining the first and second custom foot portions and the at least one second portion together at the interface using at least one of a single lapped joint, a double lapped joint, an abutted adhesive joint, a V-notched adhesive joint, lamination, or one or more mechanical joints.

20. The method of claim 13, wherein a maximum dimension of the at least one second portion of the shear web is equal to or less than about 15 meters.
